(19) United States
(12) Patent Application Publication
(10) Pub. No.: US 2025/0078042 A1
(43) Pub. Date: Mar. 6, 2025

(54) MANAGEMENT METHOD, MANAGEMENT SYSTEM, AND NON-TRANSITORY COMPUTER-READABLE STORAGE MEDIUM

(71) Applicant: DAIKIN INDUSTRIES, LTD., Osaka (JP)

(72) Inventors: Keisuke TAKIGAWA, Osaka (JP); Yoshihiko HAGIWARA, Osaka (JP); Hiroshi HANIOKA, Osaka (JP)

(21) Appl. No.: 18/952,253

(22) Filed: Nov. 19, 2024

Related U.S. Application Data
(63) Continuation of application No. PCT/JP2023/007590, filed on Mar. 1, 2023.

(30) Foreign Application Priority Data
May 26, 2022 (JP) 2022-085698
May 26, 2022 (JP) 2022-085699

(51) Int. Cl. G06Q 10/20; G06Q 30/01

(52) U.S. Cl. CPC G06Q 10/20; G06Q 30/01

(57) ABSTRACT

Provided is a computer-implemented management method that registers information for providing a subscription service in a management system that provides a maintenance service using operation data of an air conditioner. The computer-implemented management method includes: receiving the operation data from the air conditioner through a communication network; storing management information in a memory, the management information being for providing the maintenance service using the received operation data stored in the memory, the management information including customer information and device information; and registering in the memory, as part of the management information, information relevant to the subscription service such that the information registered in the memory is distinguishable between the maintenance service and the subscription service.

### CROSS-REFERENCE TO RELATED APPLICATION

The present application is a continuation application of International Application No. PCT/JP2023/007590 filed on Mar. 1, 2023, which is based on and claims priority to Japanese Patent Application No. 2022-85698 filed on May 26, 2022 and Japanese Patent Application No. 2022-85699 filed on May 26, 2022. The contents of these applications are incorporated herein by reference in their entirety.

### TECHNICAL FIELD

The present disclosure relates to a management method, a management system, and a non-transitory computer-readable storage medium.

### BACKGROUND ART

Facility devices installed in property, such as offices, stores, or the like, need to be inspected periodically. Among facility devices, there are devices on which periodical inspections need to be performed as a legal requirement, such as air conditioners, and the like. Considering such circumstances, a maintenance service that performs an inspection, repair, or the like using operation data collected from an air conditioner has been provided.

A communication control device configured to connect with an outdoor unit of an air conditioner is used for collecting operation data from the air conditioner (see, for example Patent Document 1). The communication control device periodically transmits operation data, which is recorded using various sensors built in the air conditioner, to a management device via a communication network, such as the internet or the like.

There is a subscription service which allows an air conditioner to be used at a fixed price. The subscription service of the air conditioner allows the air conditioner to be used with regular payment of a fixed price determined by collectively calculating a cost of device, a cost of installation work, and the like. The subscription service may further include a maintenance service, such as an inspection, repair, and the like, within the fixed price.

### CITATION LIST

### Patent Document

[Patent Document 1] Japanese Unexamined Patent Application Publication No. 2019-211111

### SUMMARY

In a computer-implemented management method that registers information for providing a subscription service in a management system that provides a maintenance service using operation data of an air conditioner, the computer-implemented management method includes:
receiving the operation data from the air conditioner through a communication network;
storing management information in a memory, the management information being for providing the maintenance service using the received operation data stored in the memory, the management information including customer information and device information; and
registering in the memory, as part of the management information, information relevant to the subscription service such that the information registered in the memory is distinguishable between the maintenance service and the subscription service.

### BRIEF DESCRIPTION OF DRAWINGS

FIG. 1 is a block diagram illustrating one example of an overall configuration of an air-conditioning management system according to a first embodiment;

FIG. 2 is a block diagram illustrating one example of a hardware configuration of a maintenance management device;

FIG. 3 is a block diagram illustrating one example of a hardware configuration of an air conditioner;

FIG. 4 is a block diagram illustrating one example of a functional configuration of the maintenance management device according to the first embodiment;

FIG. 5 is a conceptual diagram illustrating maintenance management information according to the first embodiment;

FIG. 6 is a conceptual diagram illustrating one example of the maintenance management information according to the first embodiment;

FIG. 7 is a conceptual diagram illustrating one example of the maintenance management information according to the first embodiment;

FIG. 8 is a flowchart illustrating a process flow of an air-conditioning management method according to the first embodiment;

FIG. 9 is a block diagram illustrating one example of an overall configuration of an air-conditioning management system according to a second embodiment;

FIG. 10 is a block diagram illustrating one example of a functional configuration of a contract management device according to the second embodiment;

FIG. 11 is a conceptual diagram illustrating one example of maintenance management information according to the second embodiment;

FIG. 12 is a conceptual diagram illustrating one example of contract management information according to the second embodiment; and

FIG. 13 is a flowchart illustrating a process flow of an air-conditioning management method according to the second embodiment.

### DESCRIPTION OF EMBODIMENTS

Embodiments of the present disclosure will be described with reference to the accompanying drawings hereinafter. Note that constituent components having substantially the same functional configuration are denoted by the same reference numeral in the specification and the drawings, and the redundant description is omitted.

### First Embodiment

A first embodiment of the present disclosure is directed to an air-conditioning management system that provides a maintenance service using operation data of an air conditioner. The air-conditioning management system of the present embodiment collects operation data from the air conditioner, and manages information for providing the maintenance service of the air conditioner, such as inspection, repair, or the like, using the operation data of the air conditioner.

The air-conditioning management system of the present embodiment registers, in the maintenance service information regarding the maintenance service (may be merely referred to as “information regarding the maintenance service” or “maintenance service information” hereinafter), information indicating whether or not a subscription service is used. Thus, the air-conditioning management system of the present embodiment can determine whether or not a target device of the maintenance service that is provided using the operation data is covered under the subscription service.

### <System Configuration>

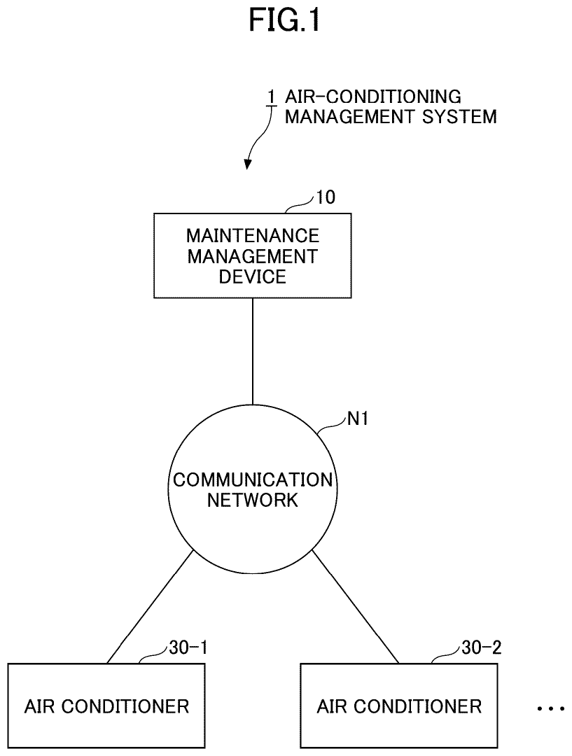

FIG. 1 is a block diagram illustrating one example of an overall configuration of the air-conditioning management system 1 according to the present embodiment. As illustrated in FIG. 1, the air-conditioning management system 1 of the present embodiment includes a maintenance management device 10 and one or more air conditioners 30.

The maintenance management device 10 and each of the one or more air conditioners 30 are communicatively coupled to each other via a communication network N1 (e.g., a local area network (LAN), internet, etc.). The communication network N1 may include, for example, wireless LAN (e.g., Wi-Fi (registered trademark) etc.), a mobile communication network (e.g., long term evolution (LTE), the 5th generation mobile communication system (5G), etc.), or a network using specific low power wireless communication (e.g., low power wide area (LPWA), etc.).

The maintenance management device 10 is an information processing device (e.g., a personal computer, a workstation, a server, etc.) that manages a maintenance service provided to each user who uses a corresponding air conditioner 30 included in the air-conditioning management system 1. The maintenance management device 10 collects the operation data from the one or more air conditioners 30, and manages information for providing a maintenance service to each air conditioner 30 using the operation data.

The one or more air conditioners 30 are one or more facility devices that are installed in property, such as offices, stores, or the like, and perform air conditioning of the predetermined indoor space including one or more rooms. Each air conditioner 30 performs cooling, heating, air purification, ventilation, humidification, dehumidification, any combination of the foregoing, or the like on the predetermined indoor space. Each air conditioner 30 records operation data indicating a state during operation or the like, and transmits the operation data to the maintenance management device 10 at the predetermined intervals.

In the case where there are two or more air conditioners 30 and the two or more air conditioners 30 are distinguished from one another, the air conditioners are denoted by using numerical classifications, such as “air conditioner 30-1,” “air conditioner 30-2,” and the like, hereinafter.

Note that the overall configuration of the air-conditioning management system 1 illustrated in FIG. 1 is merely one example, and there are various system configuration examples that the air-conditioning management system 1 can take according to the intended use or purpose. For example, the maintenance management device 10 may be implemented by multiple computers, or may be implemented through a cloud computing service.

### <Hardware Configuration>

### <<Maintenance Management Device>>

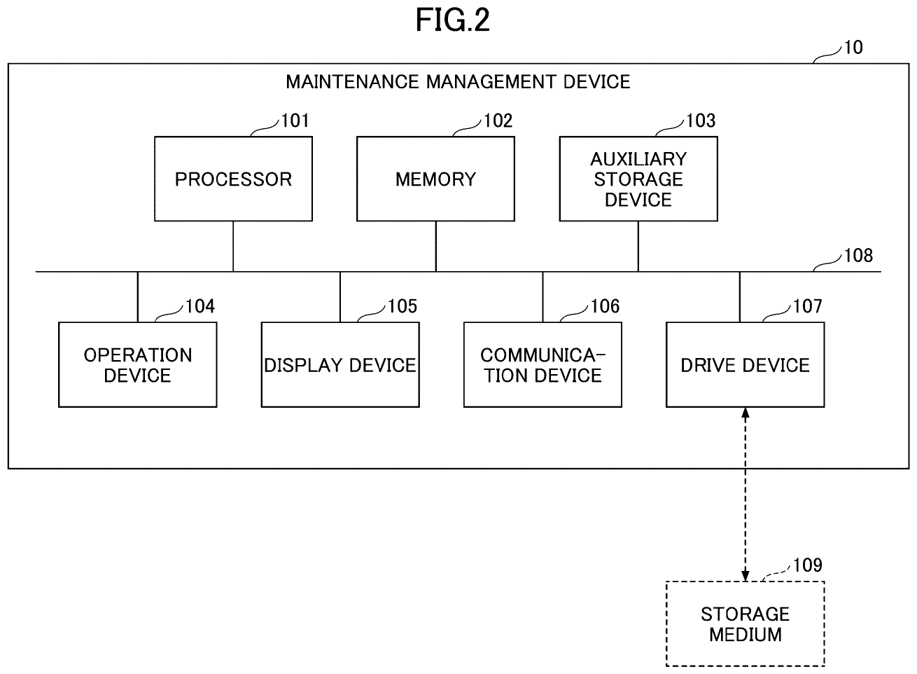

FIG. 2 is a block diagram illustrating one example of a hardware configuration of the maintenance management device 10 according to the present embodiment. As illustrated in FIG. 2, the maintenance management device 10 includes a processor 101, a memory 102, an auxiliary storage device 103, an operation device 104, a display device 105, a communication device 106, and a drive device 107. The hardware devices of the maintenance management device 10 are coupled to one another via a bus 108.

The processor 101 includes various computing devices, such as a central processing unit (CPU), and the like. The processor 101 loads one or more programs installed in the auxiliary storage device 103 into the memory 102 to execute the programs.

The memory 102 includes a main storage device, such as a read only memory (ROM), a random access memory (RAM), and the like. The processor 101 and the memory 102 constitute what is known as a computer (may be referred to as a “control unit” hereinafter). One or more programs, which are loaded into the memory 102, are executed by the processor 101, thereby allowing the computer to implement various functions.

The auxiliary storage device 103 stores one or more programs, or a variety of data used when the processor 101 executes one or more programs.

The operation device 104 is an operating device for a user of the maintenance management device 10 to perform various operations. The display device 105 is a display device that displays processing results of various processes performed by the maintenance management device 10.

The communication device 106 is a communication device that enables communication with an external device via a network (not illustrated).

The drive device 107 is a device for setting a storage medium 109. The storage medium 109 includes a medium that optically, electrically, or magnetically stores information, such as a CD-ROM, a flexible disk, a magneto-optical disk, or the like. Moreover, the storage medium 109 may include, for example, a semiconductor memory that electrically stores information, such as a ROM, a flash memory, or the like.

Note that one or more programs installed into the auxiliary storage device 103 may be installed, for example, by setting a provided storage medium 109 in the drive device 107, loading the one or more programs stored in the storage medium 109 by the drive device 107. Alternatively, one or more programs installed in the auxiliary storage device 103 may be installed by downloading the one or more programs from the network via the communication device 106.

### <<Air Conditioner>>

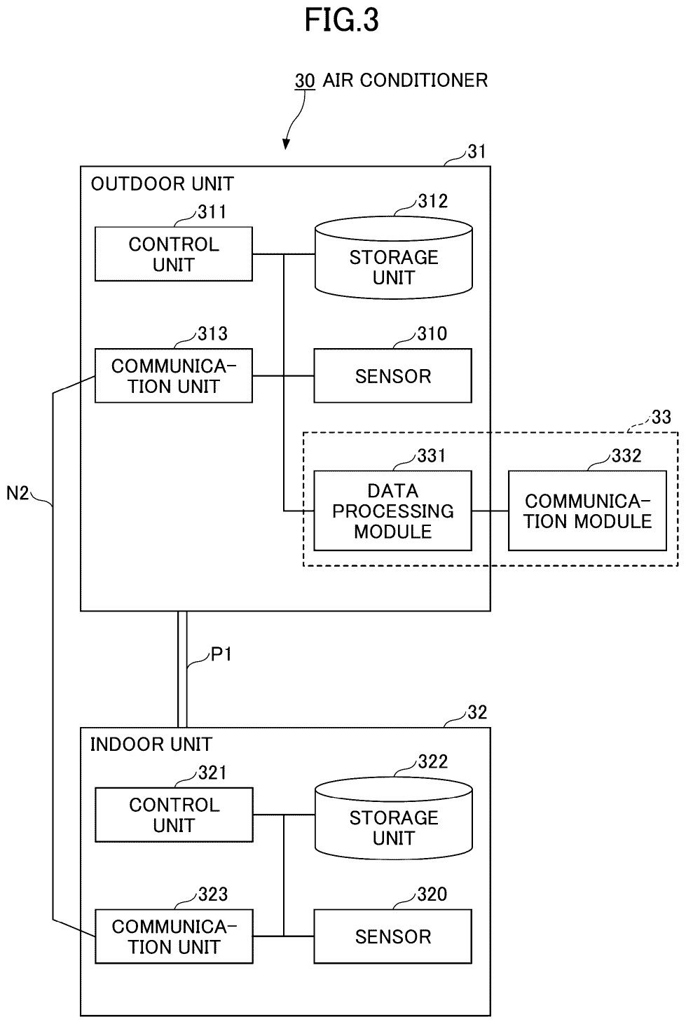

FIG. 3 is a block diagram illustrating one example of a hardware configuration of the air conditioner 30 according to the present embodiment. As illustrated in FIG. 3, the air conditioner 30 includes an outdoor unit 31 and an indoor unit 32. The air conditioner 30 may include, for example, multiple outdoor units 31 and multiple indoor units 32.

The outdoor unit 31 is installed outside an indoor space in which air conditioning is performed. The indoor unit 32 is installed inside the indoor space in which air conditioning is performed. The outdoor unit 31 and the indoor unit 32 are coupled to each other with a refrigerant pipe P1, which constitute a refrigerant circuit where a vapor compression refrigeration cycle is achieved by circulation of a refrigerant flowed inside the refrigerant pipe P1.

The outdoor unit 31 includes various sensors 310, a control device (a computer) 311, a storage device 312, and a communication device 313. The sensors 310 included in the outdoor unit 31 are, for example, a temperature sensor and a pressure sensor. The temperature sensor includes an intake-pipe temperature sensor and a discharge-pipe temperature sensor. The intake-pipe temperature sensor is attached to an intake pipe of a compressor. The discharge-pipe temperature sensor is attached to a discharge pipe of the compressor. The pressure sensor includes a low pressure sensor provided at the intake side of the compressor, and a high pressure sensor provided at the discharge side of the compressor. For example, as the temperature sensor, sensors for measuring temperatures at a gas side and at a liquid side of an outdoor-side heat exchanger may be provided.

The indoor unit 32 includes various sensors 320, a control device (computer) 321, a storage device 322, and a communication device 323. The sensors 320 included in the indoor unit 32 are, for example, an intake temperature sensor.

The communication device 313 in the outdoor unit 31 and the communication device 323 in the indoor unit 32 are communicatively coupled to each other via a communication line N2.

The detection signals of the sensors 310 in the outdoor unit 31 are stored in the storage device 312 of the outdoor unit 31. The detection signals of the sensors 320 of the indoor unit 32 are transmitted to the outdoor unit 31 via the communication line N2 and stored in the storage device 312 of the outdoor unit 31.

Further, operating modes (e.g., cooling, heating, etc.), predetermined setting data, predetermined control data, anomaly data, and the like are stored in the storage device 312 of the outdoor unit 31. For example, the setting data includes a target value of an evaporation temperature, a target value of a condensation temperature, and the like. For example, the control data includes an operation time of the air conditioner 30, a number of revolutions or operation time of a compressor and a fan, an opening degree of an expansion valve, and the like. For example, the anomaly data includes an anomaly code of an anomaly that occurred during operation of the air conditioner 30, and the like. All the data stored in the storage device 312 of the outdoor unit 31 is collectively referred to as “operation data” in the present embodiment.

Note that a format of the operation data may differ depending on a model of the air conditioner 30 or the like. This is because the number and types of sensors included in the outdoor unit 31 or the indoor unit 32, controllable items, or the like are different between the old model and the new model.

The communication control device 33 is coupled to the outdoor unit 31. The communication control device 33 acquires operation data from the storage device 312 of the outdoor unit 31, and transmits the operation data to the maintenance management device 10 via the communication network N1.

The communication control device 33 includes a data processing module 331 and a communication module 332. The data processing module 331 is disposed in a space in which an option board of the outdoor unit 31 is installed, and receives power supply from a supply port for supplying power to the option board or the like. The communication module 332 is disposed in a position of the outdoor unit 31 where the communication module 332 can communicate with the outside, for example, outside a housing of the outdoor unit 31. The communication module 332 may be disposed in a position that is inside the housing of the outdoor unit 31, and is a position where radio waves are transmitted to the outside via openings or the like.

The data processing module 331 periodically transmits a data-transmission request signal to the control unit (the computer) 311 of the outdoor unit 31. The control unit (the computer) 311 of the outdoor unit 31 loads the operation data from the storage device 312 in response to the data-transmission request signal, and transmits to the data processing module 331. The data processing module 331 transfers the operation data received from 15 the control unit (the computer) 311 of the outdoor unit 31 to the communication module 332.

The communication module 332 receives the operation data from the data processing module 331. The communication module 332 transmits the operation data to the maintenance management device 10 via the communication network N1 according to a wireless communication system, such as wireless LAN, a mobile communication network, a specific lower power wireless communication, or the like. The operation data is transmitted from the communication module 332 to a server of a network provider or the like via a base station, and is transmitted from the server or the like to the maintenance management device 10 via the internet or the like.

### <Functional Configuration>

### <<Maintenance Management Device>>

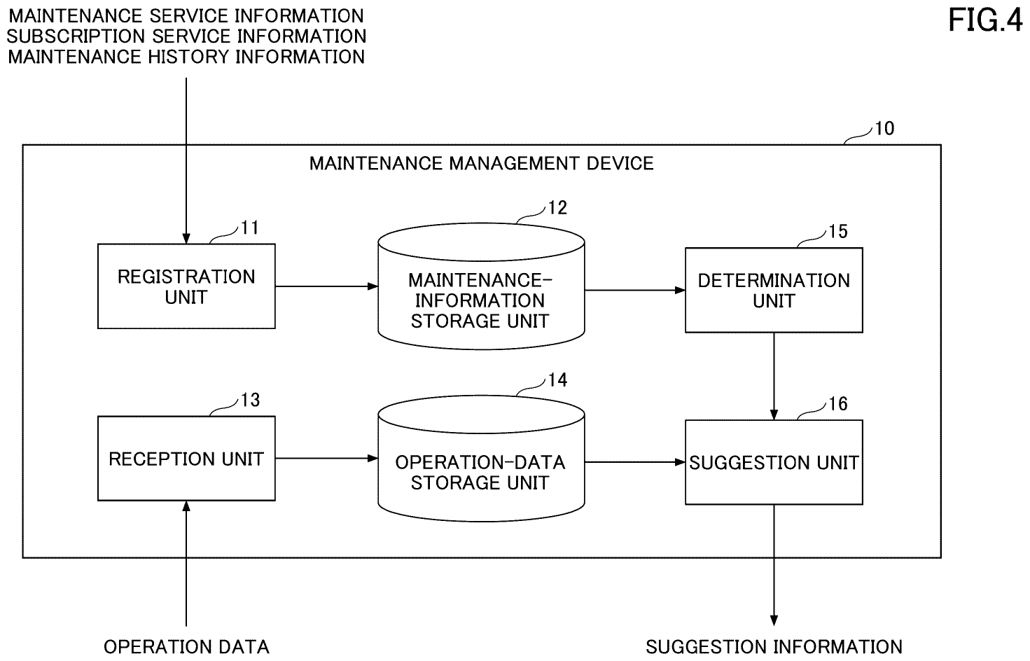

FIG. 4 is a block diagram illustrating one example of a functional configuration of the maintenance management device 10 according to the present embodiment. As illustrated in FIG. 4, the maintenance management device 10 of the present embodiment includes a registration unit 11, a maintenance-information storage unit 12, a reception unit 13, an operation-data storage unit 14, a determination unit 15, and a suggestion unit 16.

The maintenance-information storage unit 12 and the operation-data storage unit 14 are implemented by the memory 102 or the auxiliary storage device 103 illustrated in FIG. 2. The registration unit 11, the reception unit 13, the determination unit 15, and the suggestion unit 16 are implemented by allowing one or more programs, which are loaded into the memory 102, to be executed by the processor 101 illustrated in FIG. 2.

The registration unit 11 receives an input of maintenance service information and subscription service information (an example of information relevant to a subscription service) in response to an operation of a user (e.g., a user of the air conditioner 30, a system administrator, etc.) of the air-conditioning management system 1. The registration unit 11 registers the received maintenance service information and subscription service information in maintenance management information (an example of management information for providing a maintenance service) stored in the maintenance-information storage unit 12.

The maintenance service information includes customer information and device information for providing a maintenance service. The customer information is information regarding a user who has a contract for a maintenance service. The device information is information regarding the air conditioner 30 that is a target of the maintenance service.

The subscription service information is information for providing a subscription service. The subscription service information includes contract information regarding a subscription service (may be also referred to as “first contract information”), and contract information regarding an optional service (may be also referred to as “second contract information”).

When the registration unit 11 registers the subscription service information in the maintenance management information, the registration unit 11 registers and associates the first contract information regarding the subscription service and the second contract information optional service with each other. For example, the maintenance management information can be represented by one table including a column corresponding to the first contract information regarding the subscription service, and one column corresponding to the second contract information regarding the optional service. In this case, the registration unit 11 stores the first contract information regarding the subscription service and the second contract information regarding the optional service in the same record so that the first contract information regarding the subscription service and the second contract information regarding the optional service are registered and associated with each other.

In addition, the maintenance management information may be represented, for example, by multiple tables including a table corresponding to the first contract information regarding the subscription service and a table corresponding to the second contract information regarding the optional service. Each table corresponding to a respective contract information is provided with a contract ID identifying a contract of the subscription service. In this case, the registration unit 11 stores the contract ID of each table, which identifies the contract, in the record for the same contract so that the first contract information regarding the subscription service and the second contract information regarding the optional service are registered and associated with each other.

The subscription service is a service which allows the air conditioner 30 to be used at a fixed price. Costs of device and installation of the air conditioner 30 are included in the fixed price. A cost associated with a predetermined maintenance service may be included in the fixed price. The fixed price is calculated based on initial costs (e.g., a cost of device, an installation cost, etc.), a cost associated with a maintenance service provided for free, and a contract period.

The optional service is a maintenance service (e.g., an inspection, repair, etc.) provided with a fee to the air conditioner 30 covered under the subscription service. As the optional service, two or more services may be provided. In the case where two or more services can be used as the optional service, the second contract information regarding the optional service includes information whether each of services available as the optional service is used.

When the registration unit 11 registers the subscription service information in the maintenance management information, the information relevant to the subscription service is registered in a manner such that whether the air conditioner 30 is a target of the maintenance service or a target of the subscription service can be identified.

The registration unit 11 may receive an input of maintenance history information indicating a history of a maintenance service or an optional service in response to an operation of a user of the air-conditioning management system 1 (e.g., a maintenance operator). The registration unit 11 registers the received maintenance history information in the maintenance management information stored in the maintenance-information storage unit 12.

The maintenance-information storage unit 12 stores the maintenance management information including the maintenance service information and the subscription service information. For example, the maintenance history information may be registered in the maintenance management information.

The reception unit 13 receives the operation data, which is periodically transmitted by the air conditioner 30, via a communication network N1. For example, the reception unit 13 receives the operation data every 5 minutes.

The operation-data storage unit 14 stores the operation data of the air conditioner 30. The operation data is data representing a state of the air conditioner 30 during the operation. The operation data includes detection signals of various sensors installed in the air conditioner 30, setting data, control data, and anomaly data of the air conditioner 30, and the like.

The determination unit 15 determines whether or not the air conditioner 30 is covered under the subscription service based on the maintenance management information stored in the maintenance-information storage unit 12. The determination unit 15 may determines, for example, whether a specified air conditioner 30 is covered under the subscription service. In addition, the determination unit 15 may determine whether or not each air conditioner 30 is covered under the subscription service, thereby extracting each user who uses the subscription service or each user who does not use the subscription service.

The suggestion unit 16 outputs suggestion information for suggesting a service to a user of the air conditioner 30 based on the maintenance management information stored in the maintenance-information storage unit 12. The suggestion unit 16 outputs the suggestion information for suggesting an optional service to a user who uses the subscription service. On the other hand, the suggestion unit 16 outputs the suggestion information for suggesting a maintenance service to a user who does not use the subscription service.

### <<Maintenance Management Information>>

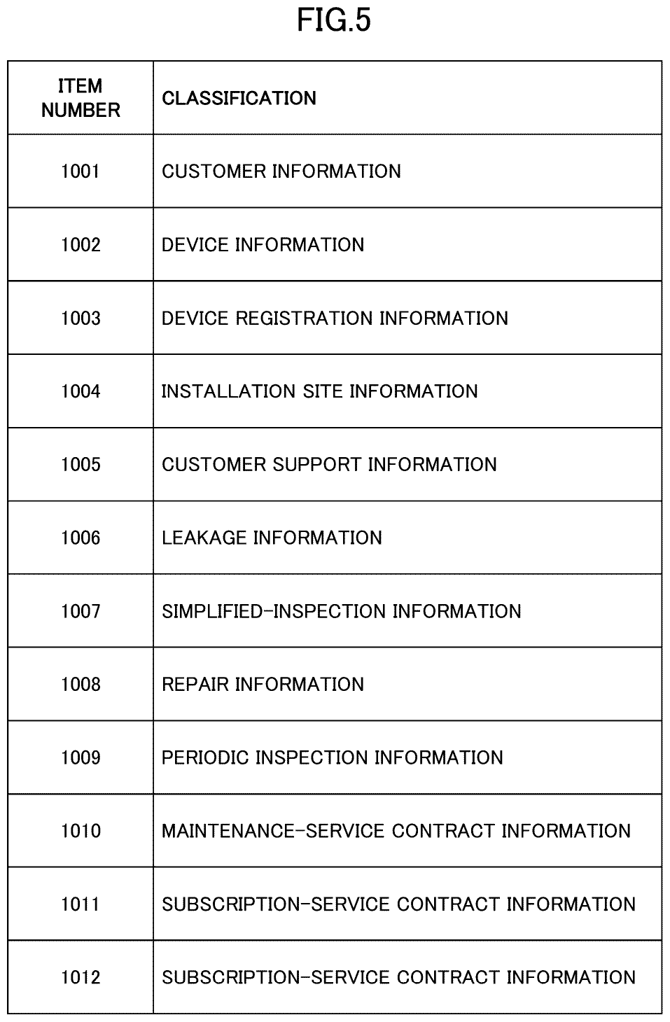

FIG. 5 is a conceptual diagram illustrating one example of the maintenance management information according to the present embodiment. As illustrated in FIG. 5, the maintenance management information of the present embodiment includes customer information (1001), device information (1002), device registration information (1003), installation site information (1004), customer support information (1005), leakage information (1006), simplified-inspection information (1007), repair information (1008), periodic inspection information (1009), maintenance-service contract information (1010), subscription-service contract information (1011), and optional-service contract information (1012).

The customer information (1001), the device information (1002), the device registration information (1003), the installation site information (1004), the customer support information (1005), and the maintenance-service contract information (1010) are included in the maintenance service information. The leakage information (1006), the simplified-inspection information (1007), the repair information (1008), and the periodic inspection information (1009) are included in the maintenance history information. The subscription-service contract information (1011) and the optional-service contract information (1012) are included in the subscription service information.

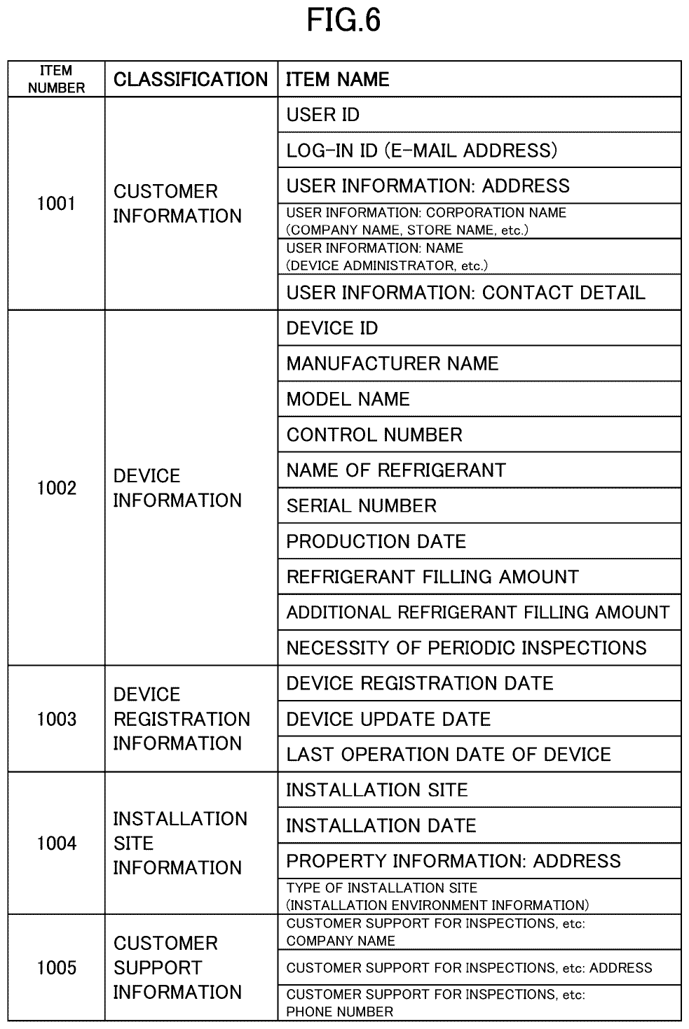

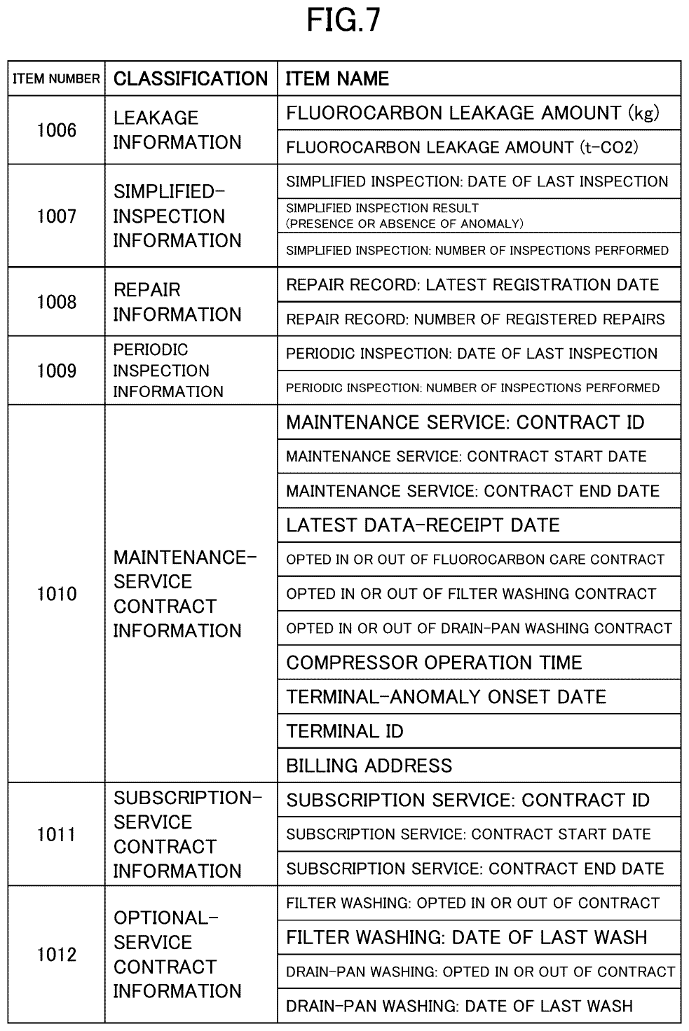

FIGS. 6 and 7 are conceptual diagrams illustrating one example of the maintenance management information according to the present embodiment in detail. As illustrated in FIG. 6, the customer information (1001) includes a user ID identifying a user, a log-in ID for logging into the air-conditioning management system 1, an address of the user, a corporation name (company name or store name) of the user, a name of a device administrator, a contact detail of the device administrator, and the like.

The device information (1002) includes a device ID identifying a device, a manufacturer name, a model name, a control number, a name of a refrigerant, a serial number, a production date, a filling amount of a refrigerant, a filling amount of an additional refrigerant, necessity of periodic inspections, and the like. The device registration information (1003) includes a device registration date on which the device information is registered, a device updated date on which the device information was updated last, the last operation date of the device on which the maintenance history information or the like was registered last, and the like.

The installation site information (1004) includes an installation site, an installation date, an address of property, a type of the installation site, and the like. The type of the installation site is information representing an environment in which the air conditioner 30 is installed. For example, the type of the installation site is information regarding a type of industry and installation site, such as an office, a restaurant (a kitchen or a dining area), a factory, an apparel store, or the like. The customer support information (1005) includes a name of a company, an address, and a phone number to which an inquiry regarding an inspection or the like can be directed.

As illustrated FIG. 7, the leakage information (1006) includes a fluorocarbon leakage amount (kg) and a fluorocarbon leakage amount (t-CO2) of fluorocarbons detected in a fluorocarbon inspection service, and the like. The simplified-inspection information (1007) includes a date on which the simplified inspection was performed last, the result of the simplified inspection (presence or absence of an anomaly), the number of the inspections performed, and the like. The repair information (1008) includes the latest registration date of a repair record, the number of registered repairs, and the like. The periodic inspection information (1009) includes a date on which the periodic inspection was performed last, the number of the inspections performed and the like.

The maintenance-service contract information (1010) includes a contract ID identifying a contract of the maintenance service, start and end dates of the contract of the maintenance service, the latest data-receipt date on which the operation data was received last, whether opted-in or opted-out of a fluorocarbon care contract, whether opted-in or opted-out of a filter washing contract, whether opted-in or opted-out of a drain-pan washing contract, an accumulated operation time of a compressor, a terminal-anomaly onset date on which an anomaly occurred in the communication control device 33 last, a terminal ID identifying the communication control device 33, a billing address to which a payment of a cost associated with the maintenance service is requested, and the like.

The subscription-service contract information (1011) includes a contract ID identifying a contract of the subscription service, start and end dates of the contract of the subscription service, and the like. The optional-service contract information (1012) includes whether opted-in or opted-out of a filter washing contract, the latest date on which the filter was washed last, whether opted-in or opted-out of a drain-pan washing contract, the latest date on which the drain pan was washed last, and the like.

The fluorocarbon care, filter washing, and drain-pan washing included in the maintenance-service contract information (1010) are merely examples of the maintenance service provided using the operation data. Information regarding a maintenance service, such as other inspections or repairs may be included in the maintenance-service contract information (1010).

The filter washing and drain-pan washing included in the optional-service contract information (1012) are merely examples of the optional service. Information of an optional service associated with a maintenance, such as other inspections or repairs, may be included in the optional-service contract information (1012).

Each item of the maintenance management information illustrated in FIGS. 6 and 7 is an example when the maintenance management information is represented by one table. In the case where the maintenance management information is represented by two or more tables, identification information associating the two or more tables with each other is added to each table. In the case where the subscription-service contract information (1011) and the optional-service contract information (1012) are represented by different tables, respectively, for example, a column for storing a contract ID of the subscription-service contract information (1011) is added to the optional-service contract information (1012).

### <Process Flow of Air-Conditioning Management Method>

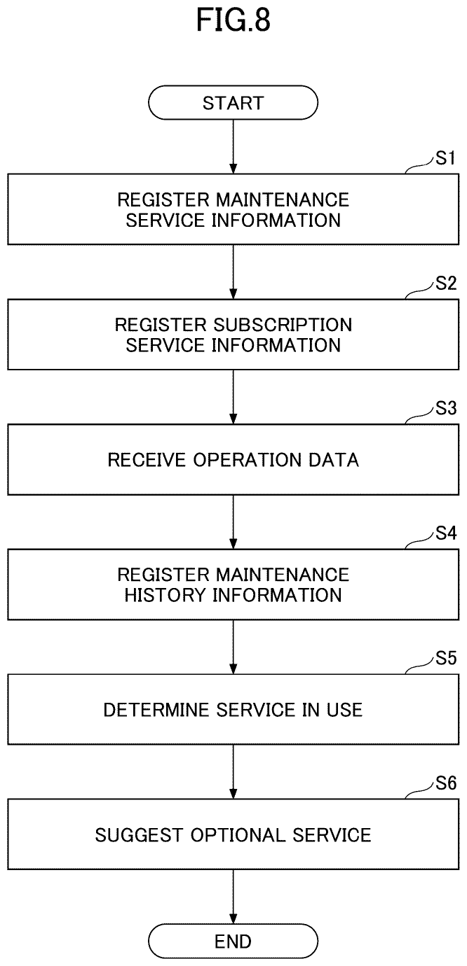

FIG. 8 is a flowchart illustrating one example of a process flow of an air-conditioning management method performed by the air-conditioning management system 1 according to the present disclosure.

At step S1, the registration unit 11 receives an input of maintenance service information in response to an operation of a user of the air-conditioning management system 1 (e.g., a user of the air conditioner 30, etc.). The registration unit 11 stores the received maintenance service information in the maintenance-information storage unit 12.

Specifically, the registration unit 11 receives an input of customer information (1001), device information (1002), installation site information (1004), customer support information (1005), and maintenance-service contract information (1010). The registration unit 11 registers each information received in the maintenance management information. During the registration, the registration unit 11 registers system date and time in a device registration date of the device registration information (1003).

At step S2, the registration unit 11 receives an input of subscription service information in response to an operation of a user of the air-conditioning management system 1 (e.g., a system administrator, etc.). The registration unit 11 stores the received subscription service information in the maintenance-information storage unit 12.

Specifically, the registration unit 11 receives an input of subscription-service contract information (1011) and optional-service contract information (1012). The registration unit 11 registers the received information in the maintenance management information. During the registration, the registration unit 11 updates the device updated date of the device registration information (1003) to system date and time.

At step S3, the communication control device 33 coupled to the air conditioner 30 acquires operation data stored in the storage device 312 of each air conditioner 30. Next, the communication control device 33 transmits the acquired operation data to the maintenance management device 10.

A reception unit 13 of the maintenance management device 10 receives the operation data from the communication control device 33. The reception unit 13 stores the received operation data in the operation-data storage unit 14.

At step S4, the registration unit 11 receives an input of maintenance history information in response to an operation of the user of the air-conditioning management system 1 (e.g., a maintenance operator). The registration unit 11 stores the received maintenance history information in the maintenance-information storage unit 12.

Specifically, the registration unit 11 receives an input of leakage information (1006), simplified-inspection information (1007), repair information (1008), or periodic inspection information (1009). The information input to the registration unit 11 may differ depending on a type of the maintenance service provided. In the case where a simplified inspection is performed, for example, simplified-inspection information (1007) is input. In the case where a fluorocarbon inspection service is provided, for example, leakage information (1006) is input. The registration unit 11 registers the received maintenance history information in the maintenance management information. During the registration, the registration unit 11 updates the last device-operation date of the device registration information (1003) to system date and time.

At step S5, the determination unit 15 determines whether or not the user of the air conditioner 30 uses the subscription service in response to an operation of the user of the air-conditioning management system 1 (e.g., a maintenance operator). In the case a certain air conditioner 30 is specified, the determination unit 15 determines whether or not the specified air conditioner 30 is covered under the subscription service.

Whether or not the subscription service is used is determined based on the subscription-service contract information (1011) of the maintenance management information stored in the maintenance-information storage unit 12. Based on the device ID of the specified air conditioner 30, the determination unit 15 loads the maintenance management information of the specified air conditioner 30 from the maintenance management information stored in the maintenance-information storage unit 12. Next, the determination unit 15 examines whether or not subscription service information is registered in the loaded maintenance management information.

In the case where a valid ID is set as the contract ID of the subscription-service contract information (1011), for example, the determination unit 15 determines that the subscription service information has been registered. In the case where the contract ID of the subscription-service contract information (1011) is not set, or an invalid ID is registered, the determination unit 15 determines that the subscription service information has not been registered.

In the case where the subscription service information is registered in the maintenance management information, the determination unit 15 determines that the specified air conditioner 30 is covered under the subscription service. In the case where the subscription service information is not registered in the maintenance management information, the determination unit 15 determines that the specified air conditioner 30 is not covered under the subscription service (namely, being covered under the maintenance service).

The determination unit 15 may extract a user who uses the subscription service or a user who does not use the subscription service in response to an operation of a user of the air-conditioning management system 1 or the like.

In the case where a user who uses the subscription service is extracted, the determination unit 15 extracts the maintenance management information in which the subscription-service contract information (1011) is registered, and outputs the customer information (1001) registered in the extracted maintenance management information. For example, the determination unit 15 extracts the maintenance management information, in which a valid ID is set as a contract ID of the subscription-service contract information (1011), as the maintenance management information in which the subscription-service contract information (1011) is registered.

In the case where a user who does not use the subscription service is extracted, the determination unit 15 extracts the maintenance management information in which the subscription-service contract information (1011) is not registered, and outputs the customer information (1001) registered in the extracted maintenance management information. For example, the determination unit 15 extracts the maintenance management information, in which a contract ID of the subscription-service contract information (1011) is not set or an invalid ID is registered, as the maintenance management information in which the subscription-service contract information (1011) is registered.

At step S6, the suggestion unit 16 outputs suggestion information, which suggests a service to the user of the air conditioner 30, to the display device 105 or the like. In the case where the user uses the subscription service, the suggestion unit 16 outputs suggestion information for suggesting a suitable optional service for the air conditioner 30 the user uses. In the case where the user does not use the subscription service (namely, uses the maintenance service), the suggestion unit 16 outputs suggestion information for suggesting a suitable maintenance service for the air conditioner 30 the user uses.

The suggestion unit 16 outputs suggestion information based on the maintenance management information stored in the maintenance-information storage unit 12 according to the preset algorithm. The suggestion unit 16 refers to the maintenance-service contract information (1010) included in the maintenance management information, and outputs suggestion information for suggesting a maintenance service for which the user has not yet signed a contract. Moreover, the suggestion unit 16 refers to the optional-service contract information (1012) included in the maintenance management information, and outputs suggestion information for suggesting an optional service for which the user has not yet signed a contract.

The suggestion unit 16 may output suggestion information based on the attribute information of the air conditioner 30. The attribute information is, for example, information regarding the installation environment of the air conditioner 30. Examples of the information regarding the installation environment include the installation site information (1004) included in the maintenance management information, and the like. In the case of installation site information (1004) indicating an environment where the air is likely to be contaminated (e.g., a workshop in a factory, a kitchen of a restaurant, etc.), filter washing or drain-pan washing may be suggested.

The suggestion unit 16 may output suggestion information based on the operation data of the air conditioner 30. For example, an accumulated operation time of a fan is calculated based on the operation data, and filter washing may be suggested when the accumulated operation time exceeds a certain period. Moreover, the suggestion unit 16 may identify a part requiring a repair or exchange based on the anomaly data or the like, and may suggest a service associated with an inspection or a repair.

### Modified Example

In the first embodiment, the maintenance management device 10 registers the subscription service information in the maintenance management information, and determines whether or not a user of the air conditioner 30 uses the subscription service based on whether or not the subscription service information is registered in the maintenance management information. The maintenance management device 10 of the modified example does not store the subscription service information, and determines whether or not a user of the air conditioner 30 uses the subscription service based on the maintenance service information registered in the maintenance management information.

The maintenance management device 10 of the modified example registers subscription service information in maintenance service information that is registered in maintenance management information. The maintenance management device 10 of the modified example determines whether or not a user of the air conditioner 30 uses the subscription service based on information relevant to the subscription service registered in the maintenance management information.

Specifically, when maintenance service information of an air conditioner 30 covered under the subscription service is registered, the registration unit 11 sets information representing a specific entity as a billing address of the maintenance-service contract information (1010). In the case where the billing address of the management information is the information representing the specific entity, the determination unit 15 determines that the user of the air conditioner 30 uses the subscription service. In the case where the billing address of the maintenance-service contract information (1010) is other than the information representing the specific entity, on the other hand, the determination unit 15 determines that the user of the specified air conditioner 30 does not use the subscription service (namely, uses a maintenance service).

An owner of the air conditioner 30 covered under the subscription service is typically a specific business operator (e.g., a leasing company), and therefore the billing address of the cost associated with the maintenance service is the business operator. In the case where the billing address of the maintenance-service contract information (1010) is a specific business operator, the air conditioner 30 can be determined as being covered under the subscription service.

### Second Embodiment

A second embodiment of the present disclosure is directed to an air-conditioning management system that provides a subscription service which allows an air conditioner to be used at a fixed price. The air-conditioning management system of the present embodiment manages information for providing the subscription service and an optional service that can be added to the subscription service.

The air-conditioning management system of the present embodiment stores first contract information regarding a subscription service and second contract information regarding an optional service added to the subscription service. Accordingly, the air-conditioning management system of the present embodiment can manage the optional service that is additionally provided to the subscription service of the air conditioner.

The air-conditioning management system 1 of the present embodiment will be described hereinafter, focusing on the difference with the first embodiment.

### <System Configuration>

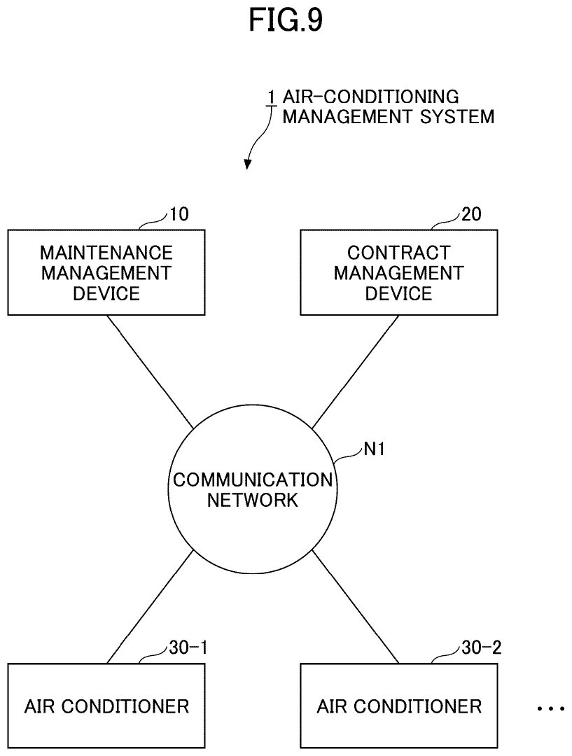

FIG. 9 is a block diagram illustrating one example of an overall configuration of the air-conditioning management system 1 of the present embodiment. As illustrated in FIG. 9, the air-conditioning management system 1 of the present embodiment includes a maintenance management device 10, a contract management device 20, and one or more air conditioners 30.

The contract management device 20 is an information processing device (e.g., a personal computer, a workstation, a server, etc.) that manages a subscription service provided to each user who uses a corresponding air conditioner 30 included in the air-conditioning management system 1. The contract management device 20 manages contract management information for providing a subscription service and an optional service. In addition, the contract management device 20 outputs suggestion information for suggesting an optional service to a user of the subscription service based on the contract management information.

### <Hardware Configuration>

### <<Contract Management Device>>

A hardware configuration of the contract management device 20 of the present embodiment is identical to the hardware configuration of the maintenance management device 10 of the first embodiment. The contract management device 20 of the present embodiment includes a processor 101, a memory 102, an auxiliary storage device 103, an operation device 104, a display device 105, a communication device 106, and a drive device 107. The hardware devices of the contract management device 20 are coupled to one another via a bus 108.

### <Functional Configuration>

### <<Maintenance Management Device>>

The maintenance management device 10 of the present embodiment includes a registration unit 11, a maintenance-information storage unit 12, a reception unit 13, and an operation-data storage unit 14. The maintenance management device 10 of the present embodiment is different from the maintenance management device 10 of the first embodiment in that the maintenance management device 10 of the present embodiment does not include the determination unit 15 and the suggestion unit 16, and the maintenance management information stored in the maintenance-information storage unit 12 in the present embodiment is different from that of the first embodiment.

### <<Contract Management Device>>

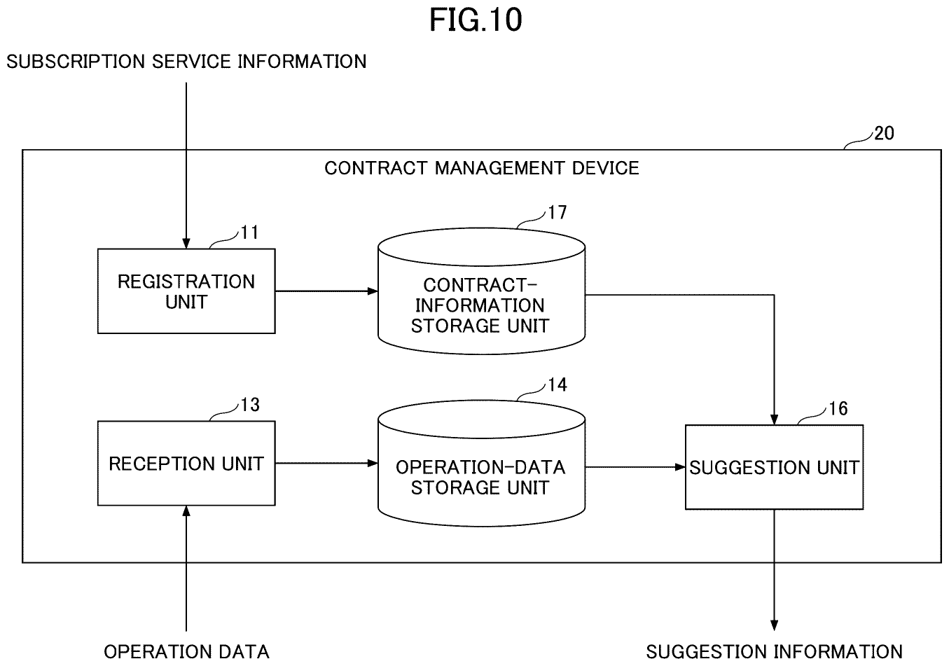

FIG. 10 is a block diagram illustrating one example of a functional configuration of the contract management device 20 of the present embodiment. As illustrated in FIG. 10, the contract management device 20 of the present embodiment includes a registration unit 11, a reception unit 13, an operation-data storage unit 14, a suggestion unit 16, and a contract-information storage unit 17. The contract management device 20 of the present embodiment is different from the maintenance management device 10 of the first embodiment in that the contract management device 20 does not include the determination unit 15, and includes a contract-information storage unit 17 instead of the maintenance-information storage unit 12.

The registration unit 11 of the present embodiment receives an input of subscription service information in response to an operation by a user of the air-conditioning management system 1 (e.g., a system administrator, etc.). The registration unit 11 stores the received subscription service information in the contract-information storage unit 17. Similar to the first embodiment, the subscription service information includes first contract information regarding a subscription service and second contract information regarding an optional service.

When the subscription service information is registered in the contract management information, the registration unit 11 registers and associates the first contract information regarding the subscription service and the second contract information regarding the optional service with each other. For example, the contract management information can be represented by one table including a column corresponding to the first contract information regarding the subscription service and a column corresponding to the second contract information regarding the optional service. In this case, the registration unit 11 stores the first contract information regarding the subscription service and the second contract information regarding the optional service in the same record so that the first contract information regarding the subscription service and the second contract information regarding the optional service are registered and associated with each other.

In addition, the contract management information may be represented, for example, by multiple tables including a table corresponding to the first contract information regarding the subscription service and a table corresponding to the second contract information regarding the optional service. Each table corresponding to a respective contract information can be provided with a contract ID identifying a contract of the subscription service. In this case, the registration unit 11 stores the contract ID of each table, which identifies the contract, in the record for the same contract so that the first contract information regarding the subscription service and the second contract information regarding the optional service are registered and associated with each other.

The contract management information including the subscription service information is stored in the contract-information storage unit 17. The first contract information regarding the subscription service and the second contract information regarding the optional service are associated with each other and registered in the contract management information.

Customer information and device information of the air conditioner 30 may be registered in the contract management information. The customer information and device information to be registered in the contract management information may be periodically acquired from the maintenance-information storage unit 12 included in the maintenance management device 10.

The suggestion unit 16 of the present embodiment outputs suggestion information for suggesting an optional service to a user of the air conditioner 30 based on the contract management information stored in the contract-information storage unit 17.

### <<Maintenance Management Information>>

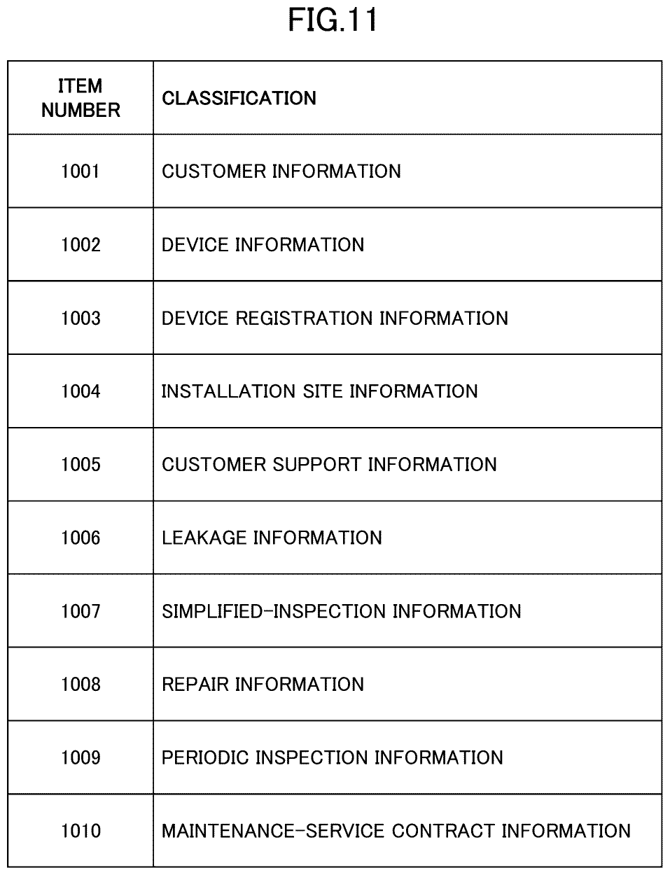

FIG. 11 is a conceptual diagram illustrating one example of the maintenance management information according to the present embodiment. As illustrated in FIG. 11, the maintenance management information of the present embodiment includes customer information (1001), device information (1002), device registration information (1003), installation site information (1004), customer support information (1005), leakage information (1006), simplified-inspection information (1007), repair information (1008), periodic inspection information (1009), and maintenance-service contract information (1010).

The maintenance management information of the present embodiment is different from the maintenance management information of the first embodiment in that maintenance management information of the present embodiment does not include the subscription-service contract information (1011) and the optional-service contract information (1012).

### <<Contract Management Information>>

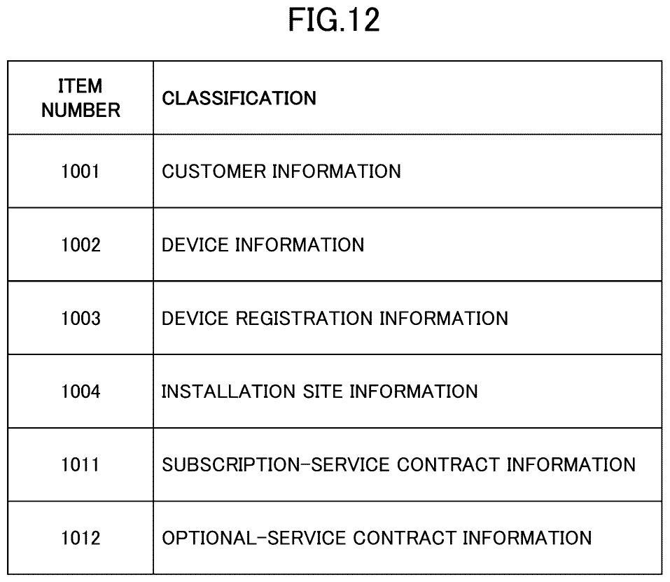

FIG. 12 is a conceptual diagram illustrating one example of the contract management information according to the present embodiment. As illustrated in FIG. 12, the contract management information of the present embodiment includes customer information (1001), device information (1002), device registration information (1003), installation site information (1004), subscription-service contract information (1011), and optional-service contract information (1012).

### <Process Flow of Air-Conditioning Management Method>

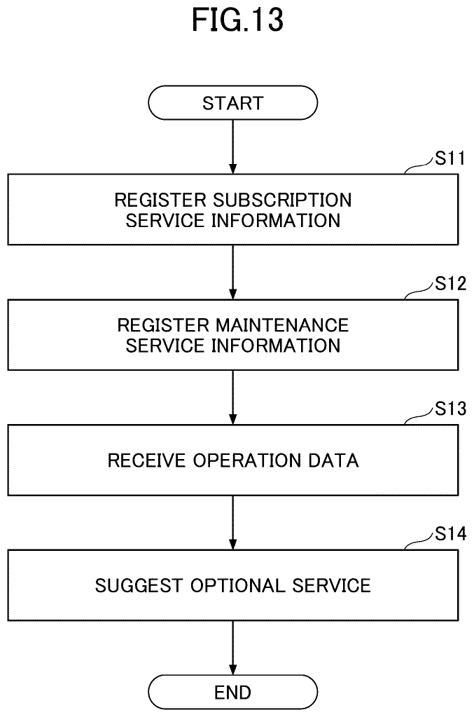

FIG. 13 is a flowchart illustrating one example of a process flow of the air-conditioning management method performed by the air-conditioning management system 1 of the present embodiment.

At step S11, the registration unit 11 receives an input of subscription service information in response to an operation of a user of the air-conditioning management system 1 (e.g., a system administrator, etc.). The registration unit 11 stores the received subscription service information in the contract-information storage unit 17.

At step S12, the registration unit 11 loads the maintenance management information from the maintenance-information storage unit 12 of the maintenance management device 10. The maintenance management information loaded by the registration unit 11 is maintenance management information of the air conditioner 30 that is a target of the subscription service information received at step S11. Next, the registration unit 11 stores, in the contract-information storage unit 17, the customer information and the device information included in the loaded maintenance management information.

At step S13, the communication control device 33 coupled to the air conditioner 30 acquires the operation data stored in the storage device 312 of the air conditioner 30. Next, the communication control device 33 transmits the acquired operation data to the maintenance management device 10.

The reception unit 13 of the maintenance management device 10 receives the operation data from the communication control device 33. The reception unit 13 stores the received operation data in the operation-data storage unit 14.

At step S14, the suggestion unit 16 outputs suggestion information, which suggests an optional service to a user of the air conditioner 30, to the display device 105.

The suggestion unit 16 outputs the suggestion information based on the contract management information stored in the contract-information storage unit 17 according to the preset algorithm. The suggestion unit 16 refers to the optional-service contract information (1012) and outputs suggestion information for suggesting an optional service for which the user has not yet signed a contract.

The suggestion unit 16 may output suggestion information based on the attribute information of the air conditioner 30. Moreover, the suggestion unit 16 may output suggestion information based on the operation data of the air conditioner 30.

### Conclusion

As described above, according to the embodiments of the present embodiment, it is possible to determine whether or not a target device of a maintenance service provided using operation data is covered under a subscription service. The air-conditioning management system 1 of the first embodiment manages the maintenance service using the operation data of the air conditioner 30. The air-conditioning management system 1 stores management information for providing the maintenance service, where the management information includes customer information and device information, and registers information relevant to a subscription service in the management information in a manner such that the maintenance service and the subscription service are distinguishable from each other. Accordingly, the air-conditioning management system 1 of the first embodiment can determine whether or not a target device of the maintenance service provided using the operation data is covered under the subscription service.

Moreover, the embodiments of the present disclosure can manage an optional service that is provided additionally to the subscription service of the air conditioner. The air-conditioning management system 1 of the second embodiment manages a subscription service which allows the air conditioner 30 to be used at a fixed price. The air-conditioning management system 1 stores the first contract information regarding the subscription service and the second contract information regarding the optional service added to the subscription service, where the first contract information regarding the subscription service and the second contract information regarding the optional service are associated with each other. Thus, the air-conditioning management system 1 of the second embodiment can manage the optional service that is provided additionally to the subscription service of the air conditioner.

Further, the embodiments of the present disclosure can suggest an optional service to a user who uses the subscription service. The air-conditioning management system 1 of the embodiments outputs suggestion information for suggesting an optional service based on the management information in which the subscription-service contract information and the optional-service contract information are registered and associated with each other. Accordingly, the air-conditioning management system 1 of the embodiments can suggest the optional service to the user who uses the subscription service.

Particularly, according to the embodiments of the present disclosure, a more suitable optional service can be suggested to the user who uses the subscription service. A service provider of the subscription service can easily acquire the operation data from the time when the air conditioner is installed. Thus, a suitable optional service can be suggested based on the detailed history of the maintenance or inspections and the operation data over the entire period of use.

Although the embodiments have been described above, it is understood that various changes in forms and detail can be made in the embodiments without departing from the gist and scope of the claims.

What is claimed is:

1. A computer-implemented management method that registers information for providing a subscription service in a management system that provides a maintenance service using operation data of an air conditioner, the computer-implemented management method comprising:
receiving the operation data from the air conditioner through a communication network;
storing management information in a memory, the management information being for providing the maintenance service using the received operation data stored in the memory, the management information including customer information and device information; and
registering in the memory, as part of the management information, information relevant to the subscription service such that the information registered in the memory is distinguishable between the maintenance service and the subscription service.

2. The computer-implemented management method according to claim 1,
wherein the computer-implemented management method includes extracting a user who uses the subscription service or a user who does not use the subscription service from the management information based on the information relevant to the subscription service of the management information.

3. The computer-implemented management method according to claim 1,
wherein the computer-implemented management method includes:
storing information regarding the subscription service and information regarding an optional service that is additionally provided; and
registering, in the management information, first contract information regarding the subscription service and second contract information regarding the optional service, which is added to the first contract information, the first contract information and the second contract information being associated with each other.

4. The computer-implemented management method according to claim 3,
wherein the computer-implemented management method includes outputting suggestion information to suggest the optional service to a user who uses the subscription service.

5. The computer-implemented management method according to claim 4,
wherein the computer-implemented management method includes:
registering attribute information regarding an installation environment of the air conditioner; and
outputting the suggestion information based on the attribute information.

6. The computer-implemented management method according to claim 4,
wherein the computer-implemented management method includes:
storing the operation data; and
outputting the suggestion information based on the operation data.

7. A management system for providing a maintenance service using operation data of an air conditioner, the management system comprising:
a computer including a processor and a memory storing one or more programs,
wherein, when the one or more programs loaded into the memory are executed by the processor, the one or more programs cause the processor to perform a process including:
receiving the operation data from the air conditioner through a communication network;
storing management information in the memory, the management information being for providing the maintenance service using the received operation data stored in the memory, the management information including customer information and device information; and
registering in the memory, as part of the management information, information relevant to a subscription service such that the information registered in the memory is distinguishable between the maintenance service and the subscription service.

8. A non-transitory computer-readable storage medium having one or more programs stored therein,
wherein the one or more programs cause, when executed by a computer, the computer to perform the computer-implemented management method according to claim 1.

9. A computer-implemented management method performed by a management system that manages a subscription service of an air conditioner, the computer-implemented management method comprising:
storing, in a memory, information relevant to the subscription service, and information relevant to an optional service that is additionally provided; and
registering, in the memory, first contract information regarding the subscription service, and second contract information regarding the optional service, which is added to the first contract information, such that the first contract information and the second contract information are associated with each other.
